(19) United States
(12) Patent Application Publication
(10) Pub. No.: US 2007/0274233 A1
(43) Pub. Date: Nov. 29, 2007

(54) METHOD, APPARATUS AND SYSTEM FOR MULTI PEER TO PEER SERVICES

(76) Inventors: Amnon Ptashek, San Diego, CA (US); Balaji Tamirisa, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/753,481

(22) Filed: May 24, 2007

Related U.S. Application Data
(60) Provisional application No. 60/808,690, filed on May 25, 2006.

(51) Int. Cl. H04L 12/28; H04L 12/56

(52) U.S. Cl. 370/254; 370/401

(57) ABSTRACT

Methods and systems for techniques to enable multi peer-to-peer services are described. Terminals are enabled to recognize their peer terminals and create multipoint to multipoint peer to peer services in each of the related network protocol layers. Presence and recognition of the peers can be done by means of pre-configuration, the use of control points configuration, or any Ad-Hoc mechanism. Once a multipoint to multipoint peer to peer network is created, a set of applications and services may be utilized.

### RELATED APPLICATIONS

This application claims the benefit of U.S. Provisional Patent Applications Ser. No. 60/808,690, filed May 25, 2006, entitled “Multi Peer To Peer Services” which is hereby incorporated by reference in its entirety.

### BACKGROUND

1. Field

The present invention relates to peer to peer networking with multiple terminals, and more particularly to a system wherein terminals recognize their peer terminals and create multipoint to multipoint peer to peer services through related network protocol layers.

2. Background

With the growth of networks, and in particular, wireless networks people are accessing networks from various, different, locations. For example, using a wireless network enabled device, people can access a network as they move about.

While wireless networks have increased the mobility of user of the network it also limits users access to services and other peripheral equipment. For example, a user may be moving about and want to print something, but the user does not have access to their print that is located on their home office network.

Also, different types of services are desired by network users. For example, a user may access a network using their cell phone that supports standard cellular communications on a cellular network. But, the user may want a different type of service, such as a push to talk service, that is not supported by the cellular network.

Thus, there is a need for improved access to different network based services and equipment.

### SUMMARY

Embodiments of the present invention provide multi-peer to peer services between terminals, and between terminals and service terminals.

In one embodiment, a terminal includes a device with networking capabilities utilizing at least a subset implementation of OSI layers 1 to 7, or an IP based protocol stack. The terminal may run applications under any model, including a client-server model, for example, and includes function sets to support those applications. Function sets may include peripheral storage, screen display, and processing power. Further, a terminal is not limited to being an “End-User” device. It may be a terminal that implements a service only. Examples of a terminal include a connected Mobile/Cellular Phone, PDA, Wi-Fi-VoIP phone, a Connected Portable Media Player, a Printer, a Scanner, and Mass Storage.

In one embodiment, terminal networking functionality is structured using a protocol layering such as OSI layer 1 to 7 or a typical IP (Internet Protocol) based layering protocol, above a wireline or wireless physical medium.

In another embodiment, terminals are enabled to recognize their peer terminals and create multipoint to multipoint peer to peer services in each of the related network protocol layers. In another embodiment presence information can be used to identify multipoint to multipoint peer to peer services. Presence and recognition of the peers can be done by means of pre-configuration, the use of control points configuration, or any Ad-Hoc mechanism. Once a multipoint to multipoint peer to peer network is created, a set of applications and services may be utilized.

In another embodiment, a method of providing multi peer to peer services includes discovering terminals within a network that can provide a service. The presence and availability of the discovered terminals are advertised, along with their respective services. Remote terminals can then access the service of a selected discovered terminal.

In another embodiment, a service creation server includes a network connection that sends and receives network data. The server also includes a processor that discovers terminals on the network that can provide services, the processor produces a list of available services and outputs the list to the network to advertise the available services.

In still another embodiment, a method of providing paired services in a network includes identifying a partner device by a user device. Then establishing a partnership between the partner device and the user device such that one partner will receive and send data to the other partner during a paired service session. Sharing data between one partner and the other partner during a paired session.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a diagram illustrating an example multi peer to peer network topology that may be used in connection with various embodiments described herein;

FIG. 2 is a diagram illustrating an example of peer to peer discovery that may be used in connection with various embodiments described herein;

FIG. 3 is a diagram illustrating an example of service advertisement, description and presence that may be used in connection with various embodiments described herein;

FIG. 4 is a diagram illustrating an example of service access that may be used in connection with various embodiments described herein;

FIG. 5 is a diagram illustrating an example of peer to peer service presence and access over L2 and L3 networks that may be used in connection with various embodiments described herein;

FIG. 6 is a diagram illustrating an example of peer to peer mobile portable media player connection that may be used in connection with various embodiments described herein;

FIG. 7 is a diagram illustrating an example of peer to peer web service that may be used in connection with various embodiments described herein;

FIG. 8 is a diagram illustrating an example of peer to peer service presence observation that may be used in connection with various embodiments described herein;

FIG. 9 is a diagram illustrating an example of remote application execution that may be used in connection with various embodiments described herein;

FIG. 10 is a diagram illustrating an example of peer to peer remote speaker use that may be used in connection with various embodiments described herein;

FIG. 11 is a diagram illustrating an example of peer to peer remote screen transmission that may be used in connection with various embodiments described herein;

FIG. 12 is a diagram illustrating an example of a peer to peer live podcast that may be used in connection with various embodiments described herein;

FIG. 13 is a diagram illustrating an example of peer to peer emergency response coordination that may be used in connection with various embodiments described herein;

FIG. 14 is a diagram illustrating an example of peer to peer gaming that may be used in connection with various embodiments described herein; and

FIG. 15 is a diagram illustrating an example of a presence screen display that may be used in connection with various embodiments described herein.

FIG. 16 is a block diagram of an example embodiment of a Paired Services Instant Stream system.

FIG. 17 is a block diagram illustrating an example embodiment of states for a Paired Services.

FIG. 18 is a diagram illustrating a call flow for an embodiment of a keep alive mechanism.

FIG. 19 is a flow diagram illustrating an embodiment of an inactivity timer.

FIG. 20 is a call flow diagram of an embodiment of an instant stream (IS) communication.

FIG. 21 is a block diagram illustrating floor states for a UE.

FIG. 22 is a flow diagram illustrating an embodiment of steps a “talk” operation of a UE.

FIG. 23 is a flow diagram of an embodiment of receiving a talk burst.

### DETAILED DESCRIPTION

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Certain embodiments as disclosed herein provide Multi Peer to Peer services between terminals, and between terminals and service terminals. In one embodiment, a network includes a plurality of terminals where each of the terminals may maintain direct connectivity with any or all of the other terminals. A terminal user may execute an application that interacts with applications executed by other connected terminals users.

In another embodiment, a terminal under the coverage of a network may advertise functions and services available to peer terminals. For example, one terminal may advertise web server or database content which peer terminals may obtain after making a connection over the network.

In one embodiment, a terminal includes a device with networking capabilities utilizing at least a subset implementation of OSI layers 1 to 7, or an IP based protocol stack. The terminal may run applications under any model, including a client-server model, for example, and includes function sets to support those applications. Function sets may include peripheral storage, screen display, sensors, GPS, and processing power. Further, a terminal is not limited to being an “End-User” device. It may be a terminal that implements a service only. Examples of a terminal include a connected PDA, Mobile/Cellular Phone, Wi-Fi-VoIP phone, a Connected Portable Media Player, a Printer, a Scanner, and Mass Storage.

In another embodiment, a service terminal allows peer terminals to extend their presence information, availability, reachability and accessibility over a network.

In another embodiment, the term “presence information” is expanded from its typical definition of “people” to services, devices, capabilities, applications, networks, processes, and domains. In another embodiment, the logical presence of the foregoing can be dependent with other factors such as physical location, logical location, group membership, time and day, and security factors or group/user profiles. In one embodiment, the presentation and display of the presence information can be in any format such as “hierarchical tree” (For example a database with sub folders available) or any other. Availability and “Serviceability” can therefore be categorized into many subcategories such as “Available,” “Not Available,” “Out-Of-Service,” “No Security Access,” “Busy”, “Out-Of-Order” etc.

In one embodiment, multi-peer to peer technology can utilize conditional connectivity and services based on physical or logical terminal location. A typical use case includes pushed broadcast or advertisement by a peer terminal, based on physical presence, such as in a shopping mall. In another embodiment, physical proximity is determined based on SSID as used in Wi-Fi connectivity.

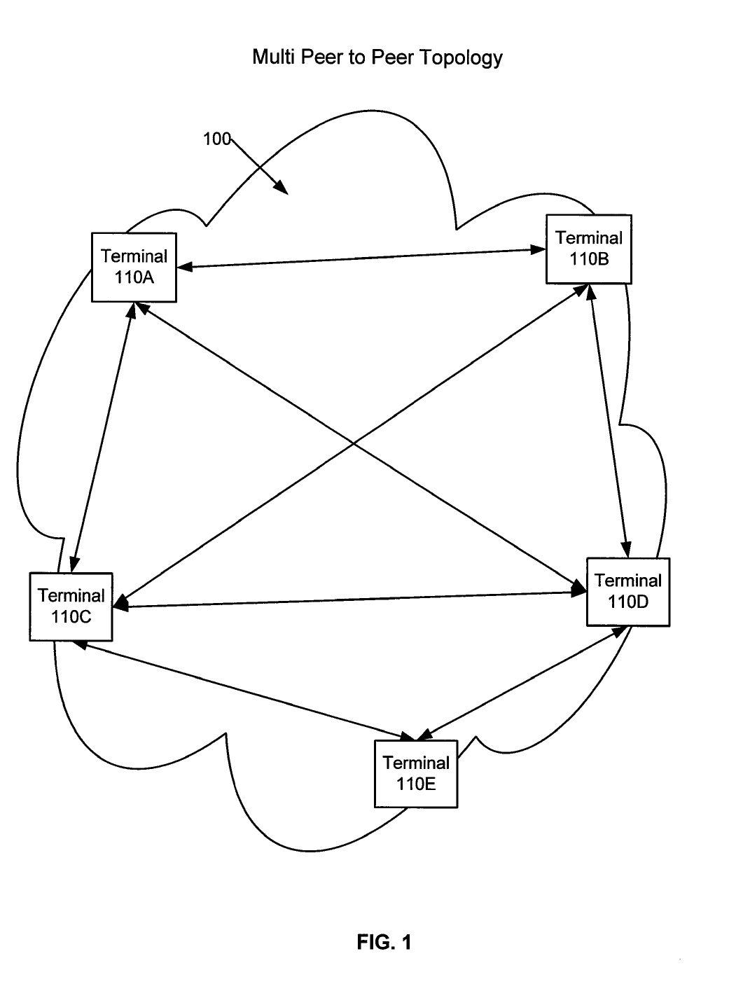

FIG. 1 is a diagram illustrating an example multi peer to peer network topology that may be used in connection with various embodiments described herein. A Multi Peer to Peer Topology is a network 100 including terminals 110A-E wherein any of the terminals 110A-E can set up direct connectivity with any or all of the other peer terminals 110A-E. In one embodiment, the connectivity can be set up using any of the relevant OSI Layers. In one example, in the case of a Wi-Fi network, each of the terminals 110A-E can set up a peer to peer Wi-Fi link with any other peer terminal 110A-E. An Internet Protocol (IP) network can be set up on top of the Wi-Fi physical connectivity and MAC layer Logical Link Control.

In another embodiment, a Multi Peer to Peer client-server architecture (not shown) can be set up, using relevant OSI layers.

In one embodiment, a limited network of two terminals 110A, 110B represents a subset of a full-scale Multi Peer to Peer network 100A-E. The topology as shown in FIG. 1 does not limit the actual connection setting between any pair of terminals 110A-E nor any specific OSI layer connectivity. In one embodiment, a limited network of a single terminal 110A represents a subset of a full-scale Multi Peer to Peer network 100A-E. That means a “loopback” of a terminal with its own “loopbacked” connection with logical services. The topology as shown in FIG. 1 does not limit the actual connection setting between any pair of terminals 110A-E nor any specific OSI layer connectivity.

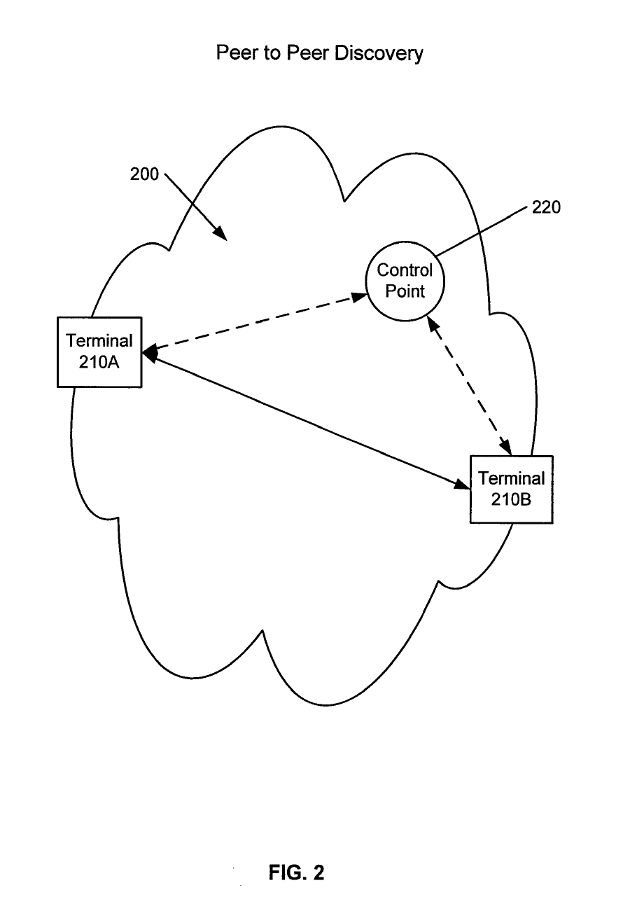

FIG. 2 is a diagram illustrating an example of peer to peer discovery that may be used in connection with various embodiments described herein. A peer to peer network 200 as shown may include terminals 210A, 210B, and a control point 220. The terminals 210A, 210B have a Peer to Peer discovery mechanism to discover and identify the existence of their peers 210A, 210B and the control point 220. The type of actual mechanism of discovery is not limited. Such discovery mechanisms can be based on industry standard protocols, proprietary protocols, and others. Examples of protocols for general discovery include:
1. Pre-Configured (IP Address and ICMP Ping Broadcast for example)
2. Ad-Hoc based (UPnP Auto IP for example)
3. Centralized by a control point (Dynamic Host Configuration Protocol (“DHCP”) Server and Internet Control Message Protocol (“ICMP”) Ping Broadcast for example)
4. JINI

Another embodiment similarly provides that terminal identification and Presence may be based on industry standard protocols, proprietary protocols, and others. Any typical standard mechanism for Presence can be utilized. Examples of protocols for general terminal identification and Presence include:
1. Pre-Configured (Wireless Village IM based for instance)
2. Ad-Hoc based (MAC Address, IP Address or UPnP Unique ID for example)
3. Centralized by a control point (BOOTP protocol for instance)
4. JINI

It will be recognized that terminal discovery and identification may be done within related layers of the OSI or IP based network in order to effect proper system operation.

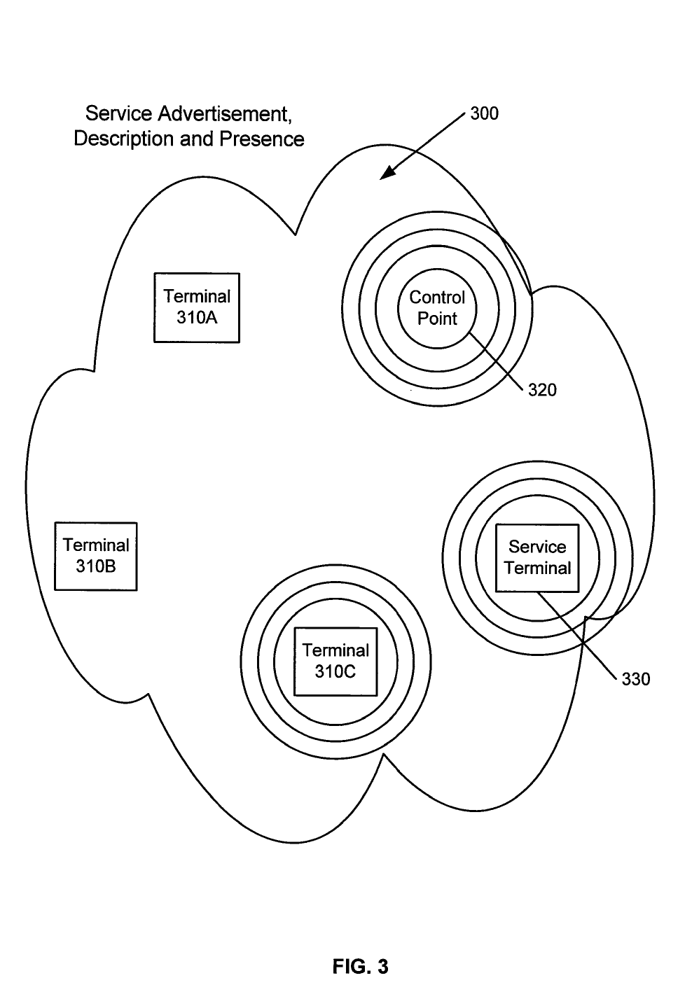

FIG. 3 is a diagram illustrating an example of service advertisement, description and presence that may be used in connection with various embodiments described herein. In the example of FIG. 3, each of the terminals 310A-C can provide a set of functions and services. Functions may include, for example, address resolution, naming resolution, overall system synchronization, time stamp, and Universal Plug and Play (“UPnP”) control point functionality. Services may include, for example, database services, content delivery, media streaming, network time services, serving Web content, and printing.

In one embodiment, the functions and services are advertised by terminal 310C, where the advertisements include a relevant service description. In one embodiment, the method for advertisement can be a direct multicast or broadcast from terminal 310C to a subset of peers such as the other terminals 31A, 310B. In another embodiment, peer terminals may extend their presence information, availability, reachability and accessibility over a network through a service terminal 330. Accordingly, a multicast or broadcast may be made indirectly by one terminal 310A, for example, to a subset of peers to a control point 320 and then forwarded to a service terminal 330, or directly to the service terminal 330.

In one embodiment, a control point 310 or any other terminal 310A-C can carry a list of services and functions available in the network. In another embodiment, a terminal 310A-C may make available its location on the network using, for example, a Universal Resource Indicator (“URI”), physical GPS location, or IP address.

In another embodiment, terminals 310A-C and one or more service terminals 320 (only one is shown in FIG. 3) can extend their Presence Information, availability, reachability and accessibility over a layer 3 network 300 through a service terminal 330, which can be any of IMS, Session Initiation Protocol (“SIP”) or Proprietary based. In this example, information about the peers, such as their presence, functions and services, is prorogated to the service terminal 330 through the control point 320, which may add additional information for the completeness of peer to peer access. In one embodiment, control point 320 functionality may be co-located in terminals 310A-C or implemented in stand alone devices such as gateways. Information about the peers can be pushed-to or pulled-by any terminal 310A-C or control point 320 in the network 300. In one embodiment, access to the information about the peers may be conditioned security or profiled-related limitations.

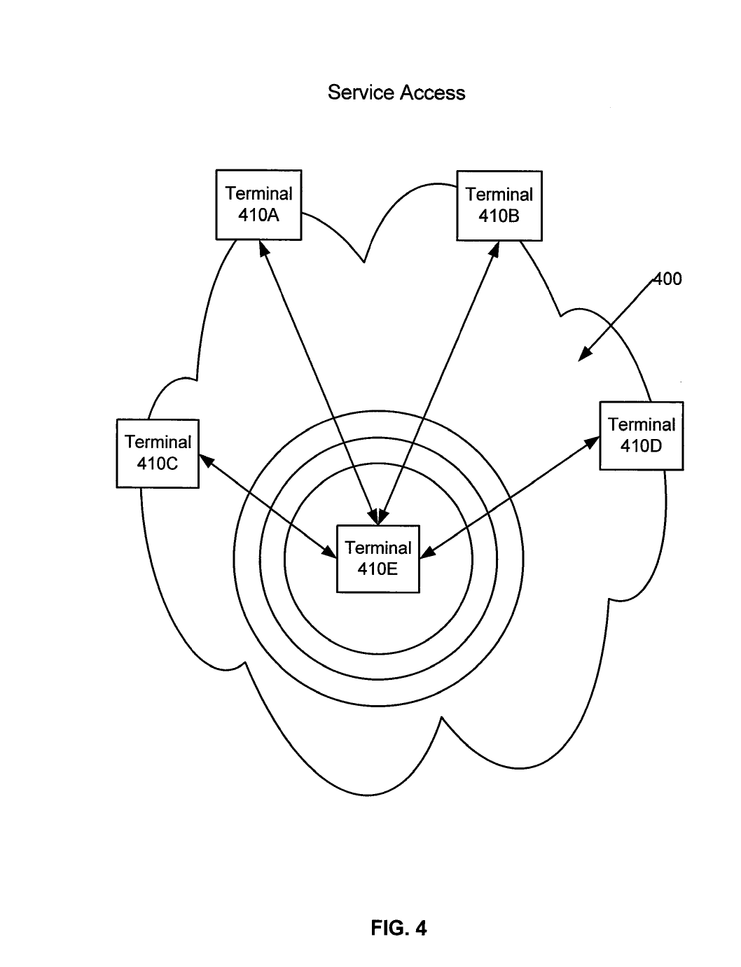

FIG. 4 is a diagram illustrating an example of service access that may be used in connection with various embodiments described herein. Each of the terminals 410A-E of the network 400 depicted in the example of FIG. 4 may carry a set of functions and services. Those functions and services are available to any terminal such as 410E itself, for example, as well as other peer terminals 410A-D. In one example, a service may include serving Web content or Database content. The services are available to each of the terminals 410A-D independently. The method of accessing those services is not limited. In one embodiment, the services can be provided under a client-server model. In another embodiment, the services can be provided through one way multicasting, or any other method.

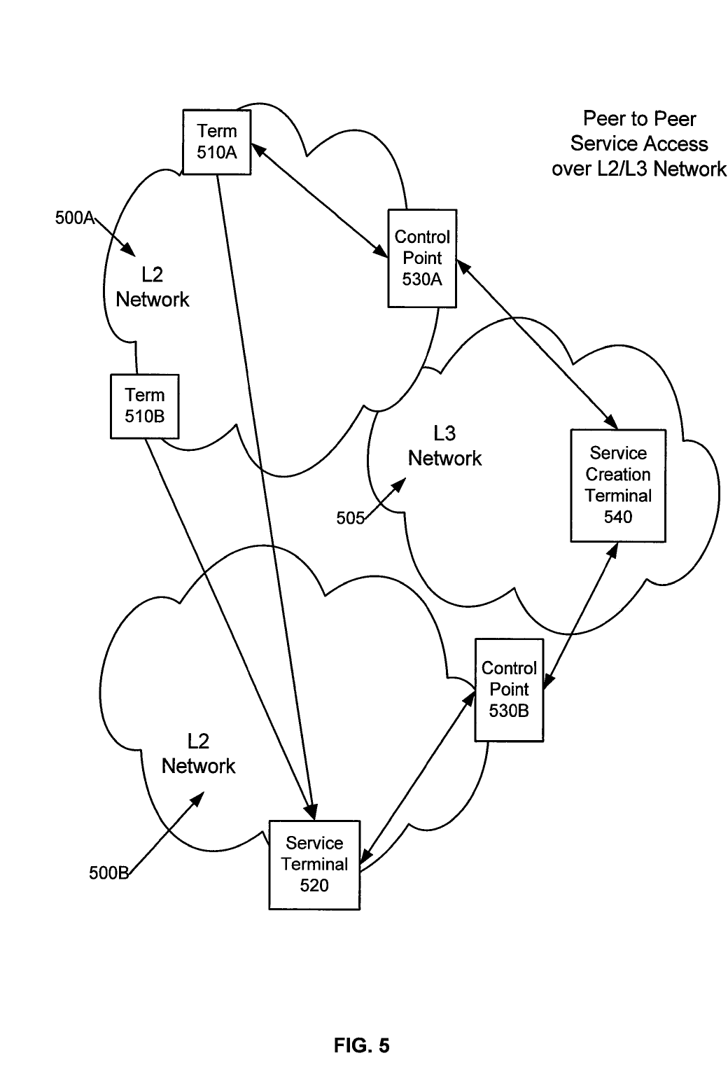

FIG. 5 is a diagram illustrating an example of peer to peer service presence and access over layer 2 (L2) and layer 3 (L3) networks that may be used in connection with various embodiments described herein. As shown in the example of FIG. 5, terminals 510A, 510B and service terminal 520 can extend their presence, availability, reachability and accessibility information from Layer 2 networks 500A, 500B over a Layer 3 network 505 through a Service Creation Server 540. In one embodiment, communication over the Layer 3 network 505 may be based on IMS (“IP Multimedia Subsystem”), Session Initiation Protocol (“SIP”), or a proprietary protocol.

In one embodiment, the information about the peers, including presence, function and services information, is propagated to the Service Creation Server 540 from a terminal 510A through a control point 530A that may add additional information to complete the peer to peer access. In another embodiment, control point 530A function may be co-located in the terminal 510A, or in stand-alone devices such as gateways (not shown). Now the information or content may be pushed-to or pulled-by any other terminal or control point in the network. In another embodiment, access to the information by a terminal or control point in the network is limited according to security or profile requirements.

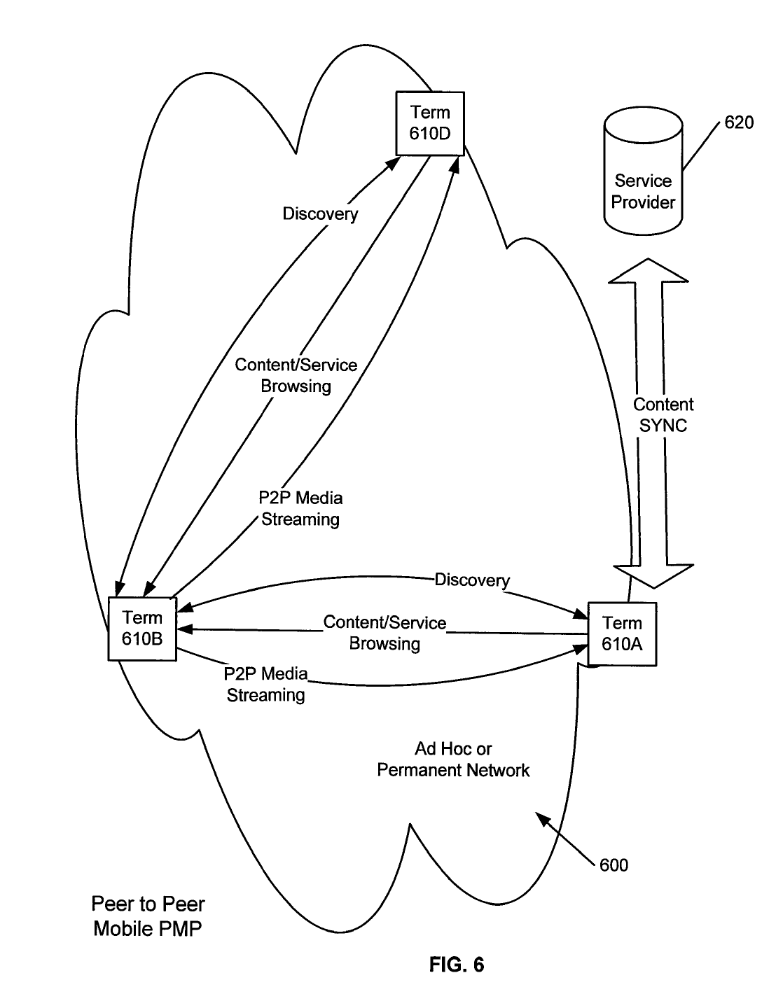

FIG. 6 is a diagram illustrating an example of peer to peer mobile portable media player connection that may be used in connection with various embodiments described herein. The example of FIG. 6 presents a use case of multi-peer to peer technology. In one embodiment, the terminals 610A-C are Mobile Portable Media Players (“PMPs” or “MPMPs”) with Wi-Fi interfaces. An MPMP 610A-C discovers its peers utilizing Ad-Hoc 802.11 networking, for example, when meeting each other or through an access point (not shown) within a Wi-Fi node's transmission range. At this stage a UPnP Protocol may be utilized to allocate Auto IP addressing, service discovery, and service description. This may be done with “Zero” configuration (i.e., no networking set-up is required). In one embodiment, the MPMPs may include a database with a search engines (such as SQL), media files, Web Servers, streaming servers, chatting clients, and the like, and can serve the other MPMPs for their content search, content browsing, media streaming and chatting. In another embodiment, content on a MPMP may be synchronized with a service provider 620 for robust data protection and content downloading. Media streaming can be done using several methods, including progressive download, classical streaming, and partial content over TCP transfer. Various implementations provide that the streamed media can be pre- or post-decoding (meaning either the content is decoded at the transmit terminal or the received terminal).

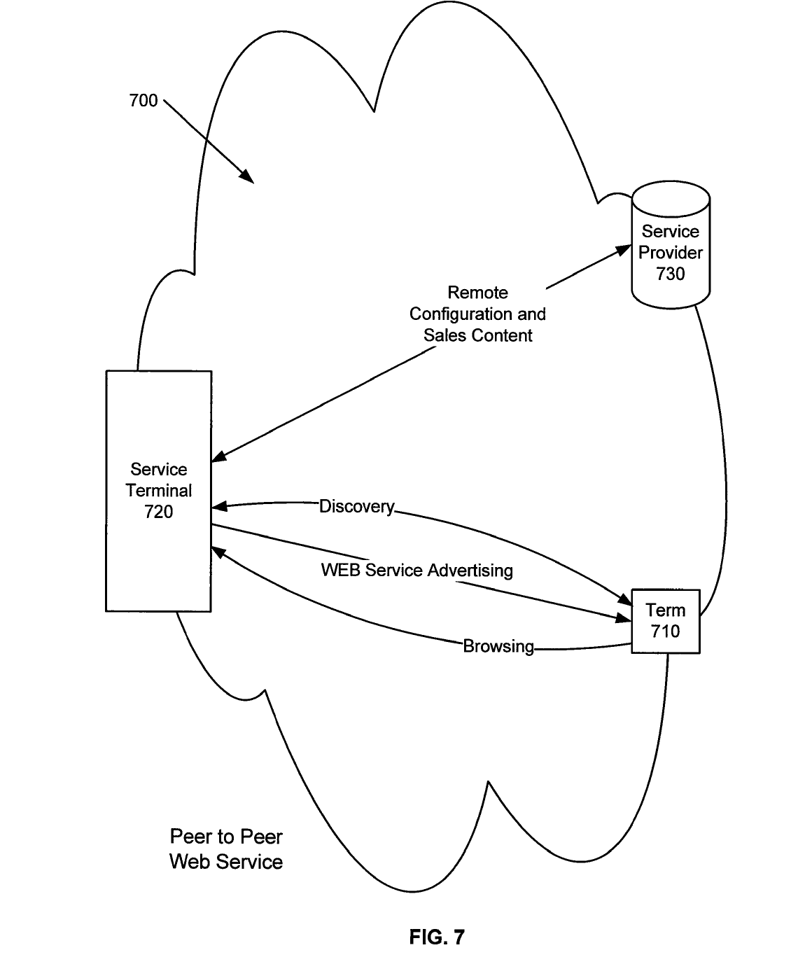

FIG. 7 is a diagram illustrating an example of peer to peer web service that may be used in connection with various embodiments described herein. FIG. 7 presents an example of a use case of a multi peer to peer technology. Here, the terminal is a mobile device 710 on one side and a point of sale (“PoS”) service terminal 720 on the other side. In one embodiment, the PoS service terminal 720 includes an embedded Web Server with related service content. Both the mobile device 710 and the PoS service terminal 720 are able to connect through Wi-Fi or Bluetooth systems with the network 700 using a public area network (“PAN”) profile. The mobile device 710 and the PoS service terminal 720 discover each other utilizing Ad-Hoc 802.11 networking when meeting each other, or through an access point (not shown) in the physical range of a Wi-Fi transmission, or Ad-Hoc through Bluetooth PAN Profile, of the network 700. At this stage UPnP Protocol is utilized to allocate IP addressing as well as service discovery and description. This is done with “Zero” configuration (i.e., no networking set-up is required). The PoS service terminal 720 advertises its Web server and the mobile terminal 710 can browse its content. Live content such as advertisements, sales incentives or refreshed content can be pushed to the mobile terminal 710 by a service provider 730 executing remote pages through the PoS service terminal 720.

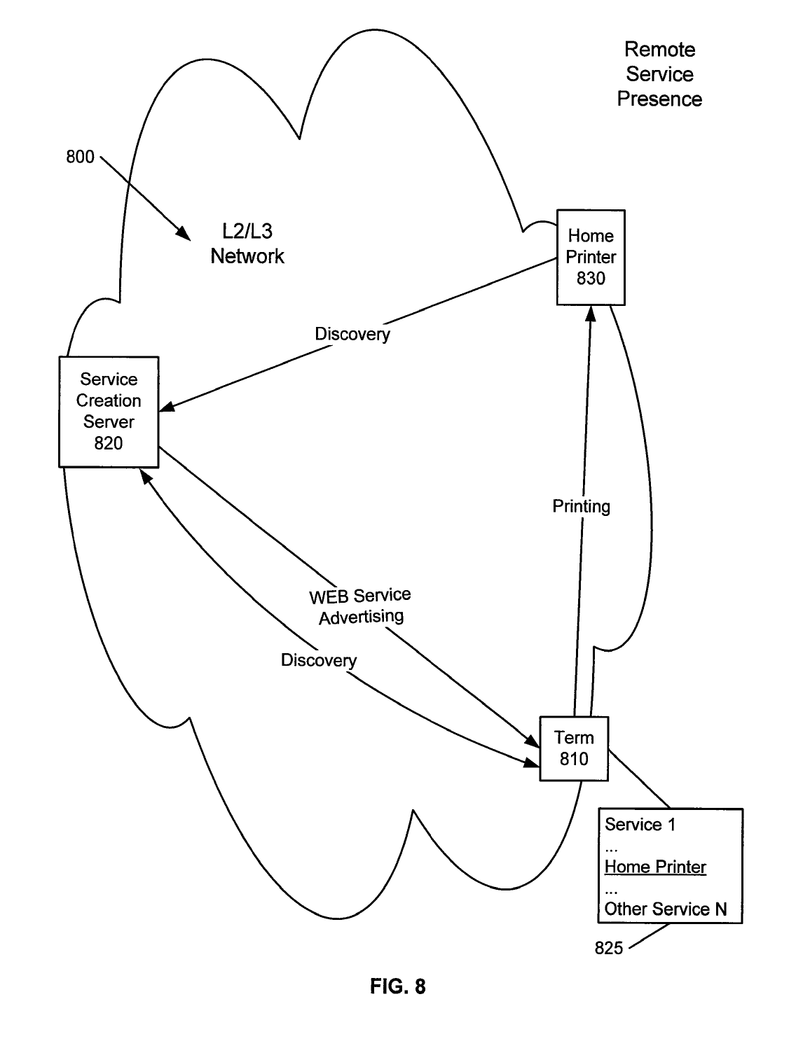

FIG. 8 is a diagram illustrating an example of peer to peer service presence observation that may be used in connection with various embodiments described herein. FIG. 8 presents another example use case of peer to peer technology, here over a L2/L3 internet-based network 800 through the use of service presence information. Peer services may be propagated over the internet 800 through a service creation server 820.

In one embodiment, as shown in FIG. 8, the service creation server 820 includes a network connection that sends and receives network data. For example, the service creation server 820 can send out queries to terminals on the network requesting information about services that the terminal can provide. The service creation server 820 can receive information, such as presence information, from terminals on the network indicating services that terminal can provide. Other information, such as the physical location of the terminal (such as GPS) and availability information can also be provided. The service creation server 820 can also include a processor (not shown) that discovers terminals on the network that can provide services, and then the processor can produce a list of available services and output the list to remote terminals on the network to advertise, or notify, the remote terminal of the available services. In one embodiment, notifying remote terminals includes comparing a physical location of a service terminal to a remote terminal and notifying the remote terminal of services within a particular geographic region. For example, a remote terminal may be notified about services that are available within a particular distance of the remote terminal. If a remote terminal is mobile, then the remote terminal can be notified about services that are within the vicinity of the remote terminal. In another embodiment, a remote unit may be notified of services that are at desired locations, such as the home, or office of the user of the remote terminal. Likewise, a mobile remote terminal may be notified of services available at desired locations, such as satellite offices as the user of the remote terminal moves about.

A remote terminal 810 can observe the available peer services and can use them wherever the remote terminal 810 is located. In one embodiment, the remote terminal 810 is a Wi-Fi enabled cell phone. In another embodiment, the remote terminal 810 is a PDA.

In one embodiment, the notification of available services is pushed to a remote terminal by the service creation server. For example, if a remote terminal is mobile, the service creation server can push lists of available services to the remote terminal as it enters different geographic regions. In another embodiment, the remote terminal can request a list of services available.

In the example of FIG. 8, a home printer 830 provides the service desired by the user of the remote terminal 810. The home printer 830 has been discovered by the service creation server 820. The service creation server 820 advertises the presence and availability of the home printer 830 onto the internet 800. Accordingly, a representation of the home printer 830 appears on the presence screen 825 of the remote terminal 810 observed by the user, listed with other services present and made available through the service creation server 820. Thus, the user may print directly to the home printer 830 wherever he or she is located.

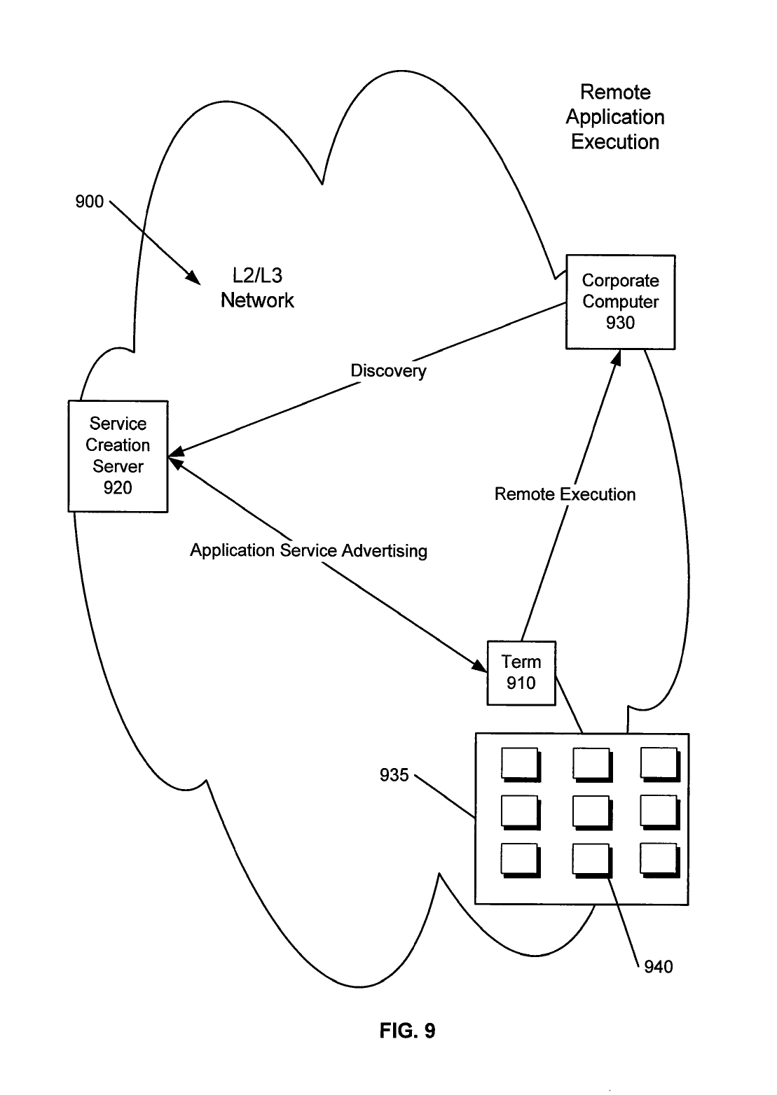

FIG. 9 is a diagram illustrating an example of remote application execution that may be used in connection with various embodiments described herein. FIG. 9 presents an example of a use case of peer to peer technology over a L2/L3 internet based network utilizing application availability and presence information. Here, the network 900 includes the internet, over which peer services are propagated through a service creation server 920. A remote terminal 910 can observe the available of peer applications and can execute them remotely. Accordingly, in this example, an application running on a corporate computer 930 can be executed from remote terminal 910. The list of available applications appears on a display 935 at the remote terminal 910 after propagating the information over the network 900 through the service creation server 920. The user may then select a representation of desired application 940 from the list presented on the display 935, and thereby execute the desired application on a corporate computer 930. In one embodiment, a variety of security conditions may be applied.

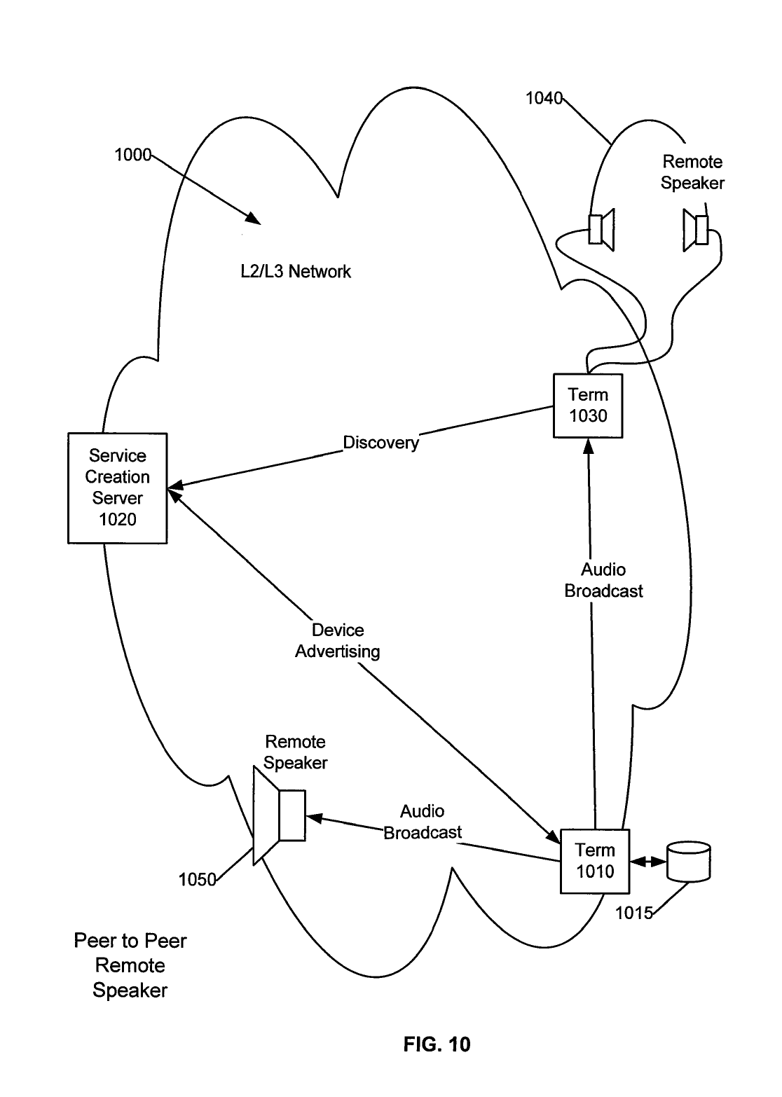

FIG. 10 is a diagram illustrating an example of peer to peer remote speaker use that may be used in connection with various embodiments described herein. This is another example of a use case of peer to peer technology over a L2 or L3 internet-based network 1000 utilizing device availability and presence information. Peer services are propagated over the internet 1000 through a service creation server 1020 after discovery. In one embodiment, the peer services may propagated locally in a L2 network (not shown). A remote terminal 1010 may observe the availability of peer devices and can transmit content remotely. In one embodiment, the content includes audio content stored in a database 1015 connected to the remote terminal 1010. In this example, audio content which is encoded and transmitted to a different remote terminal 1030 with a coupled remote speaker 1040. In one embodiment, the audio content may be transmitted unencoded. In another embodiment, the audio content may be transmitted to a second remote speaker 1050 including only a pure speaker terminal 1050 with the peer technology capabilities.

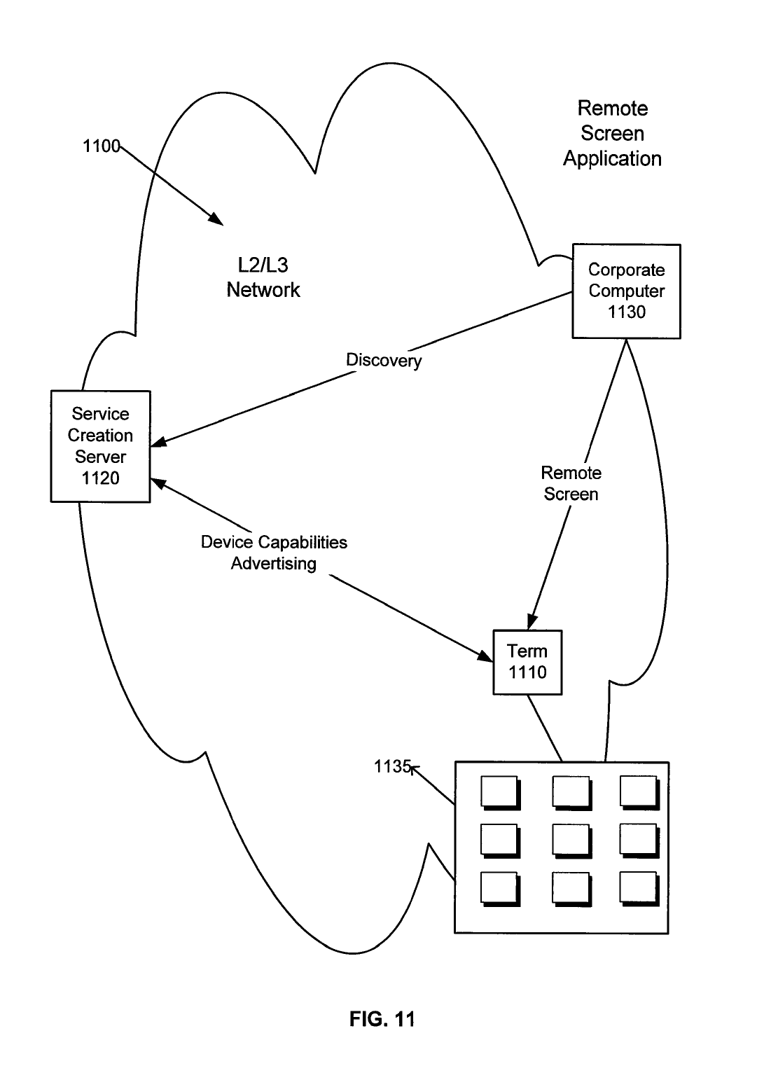

FIG. 11 is a diagram illustrating an example of peer to peer remote screen transmission that may be used in connection with various embodiments described herein. This is an example of a use case of a peer to peer technology over a L2 or L3 internet-based network 1100 with capabilities for utilizing availability and presence information. Peer services are propagated over the Internet 1100 through a service creation server 1120. In one embodiment, the peer services may propagated locally in a L2 network (not shown). A remote terminal 1110 can observe the availability of peer capabilities and can consume content from remote source. In the example of this use case, a screen transmission is transmitted to remote terminal 1110 from a corporate computer 1130 for viewing through a display 1135 connected to the remote terminal 1110. Embodiments provide for different formats and techniques of screen transmission.

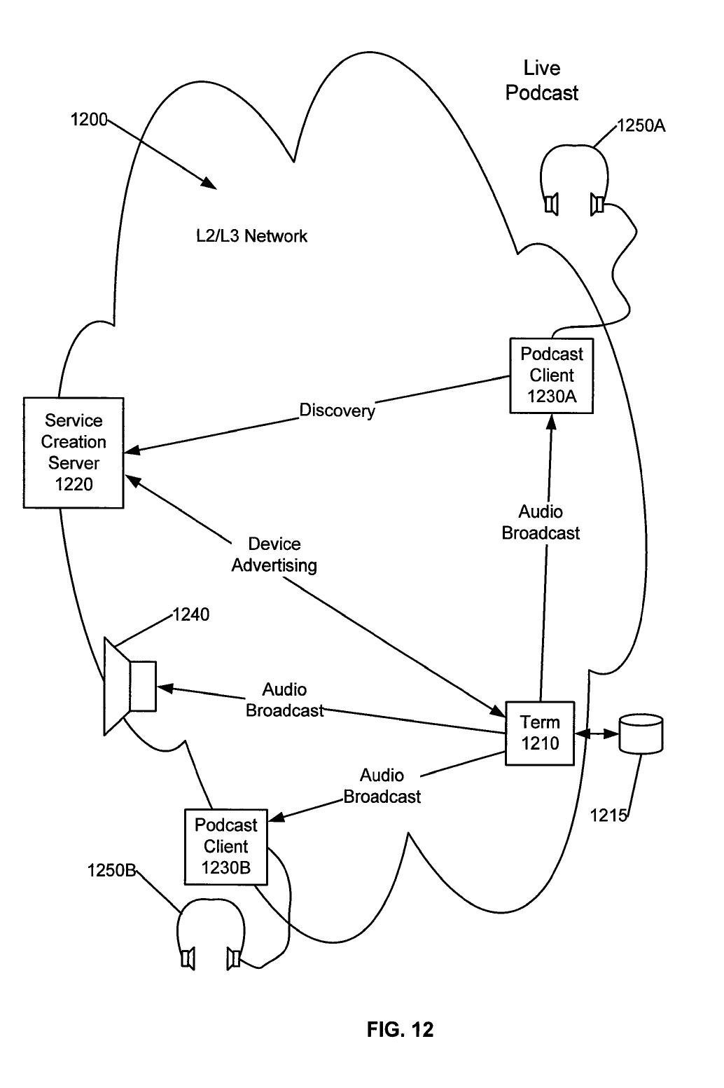

FIG. 12 is a diagram illustrating an example of a peer to peer live podcast that may be used in connection with various embodiments described herein. This is another example of a use case of a peer to peer technology over a L2 or L3 internet-based network 1200 with capabilities for utilizing availability and presence information. Peer services are propagated over the Internet 1200 through a service creation server 1220. In one embodiment, the peer services may propagated locally in a L2 network (not shown). A remote terminal 1210 can receive a live transmission of media. In the example of this use case, an audio podcast is multicast to remote receiver terminals 1230A, 1230B from a remote terminal 1210. The remote receiver terminals 1230A and 1230B may then transmit the media to headsets 1250A and 1250B respectively. Likewise, the media can be transmitted, or other wise communicated, directly from the remote terminal 1210 to a speaker 1240. In one embodiment, the audio podcast is received by the remote terminal 1210 from a connected database 1215. Embodiments further provide for intermediate devices such as servers and routers also to perform the multicasting.

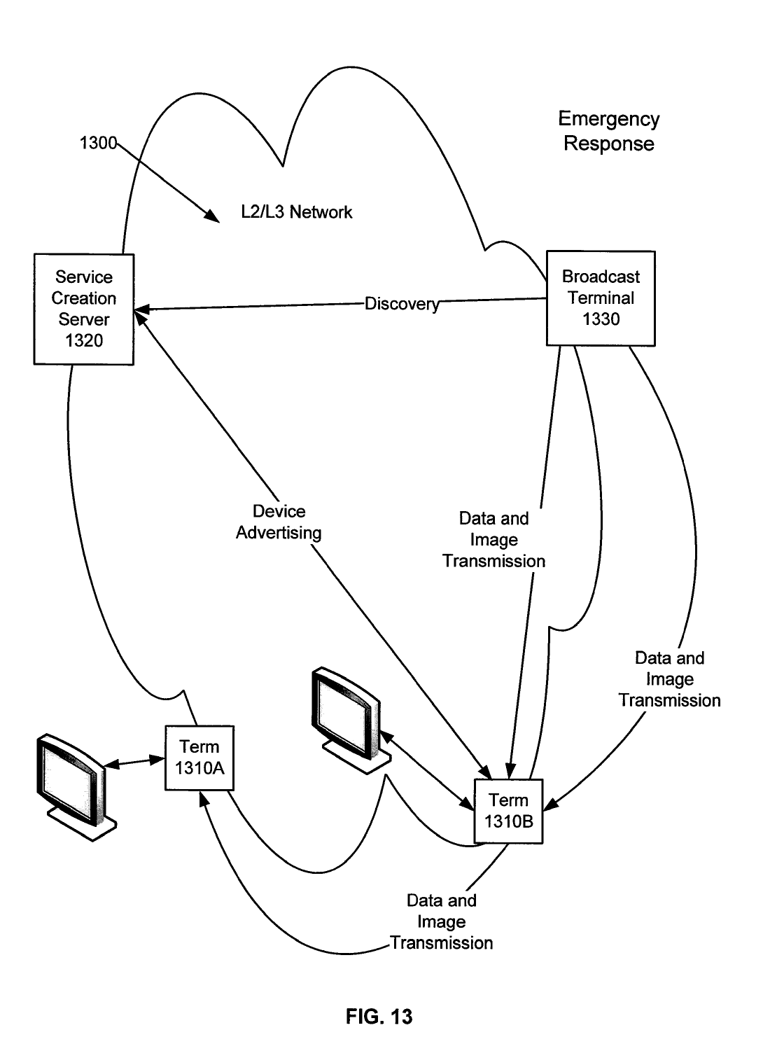

FIG. 13 is a diagram illustrating an example of peer to peer emergency response coordination that may be used in connection with various embodiments described herein.

The example of FIG. 13 is a use case of a peer to peer technology over a L2 or L3 internet-based network 1300 with services and capabilities to provide availability and presence information. Peer services are propagated over the internet 1300 through a service creation server 1320. In the example of this use case a remote broadcast terminal 1330 can have live image and video content to broadcast to authorized remote terminals 1310A, 1310B for viewing live images and other digitized information. In one embodiment, these capabilities can be applied to facilitate emergency response coordination.

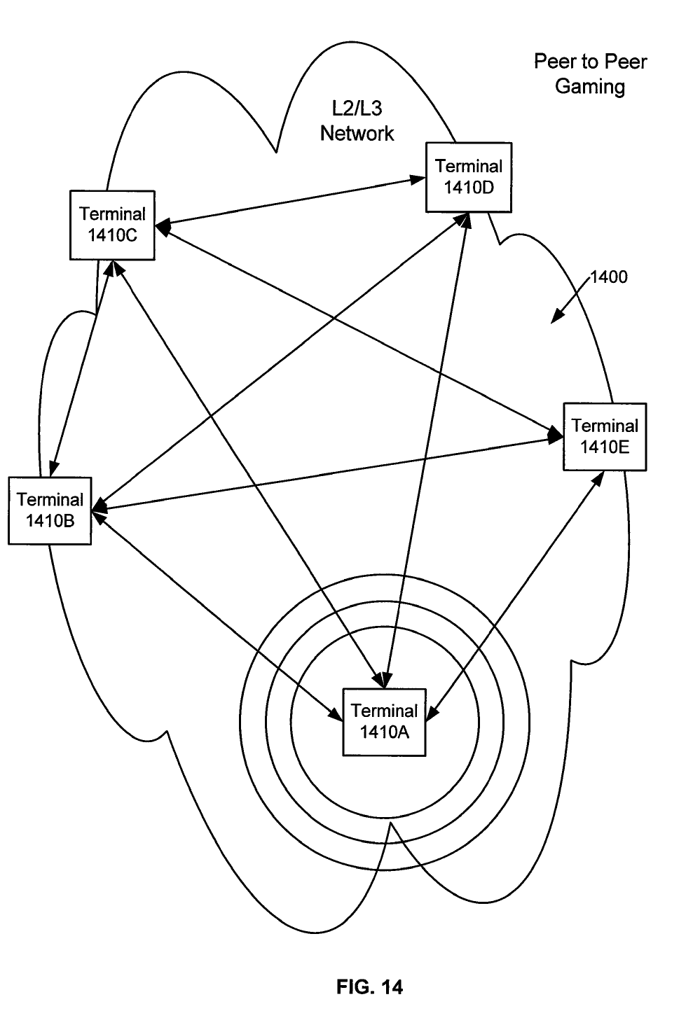

FIG. 14 is a diagram illustrating an example of peer to peer gaming that may be used in connection with various embodiments described herein. FIG. 14 presents an example of a use case of a peer to peer technology for multiplayer gaming. Peer services are propagated from a terminal 1410A locally (directly or through control points) or over the internet 1400 through a service creation server (not shown). Terminals 1410B-E running gaming applications can implement multi-peer to peer interactions. In one embodiment, application availability can be divided into groups of players.

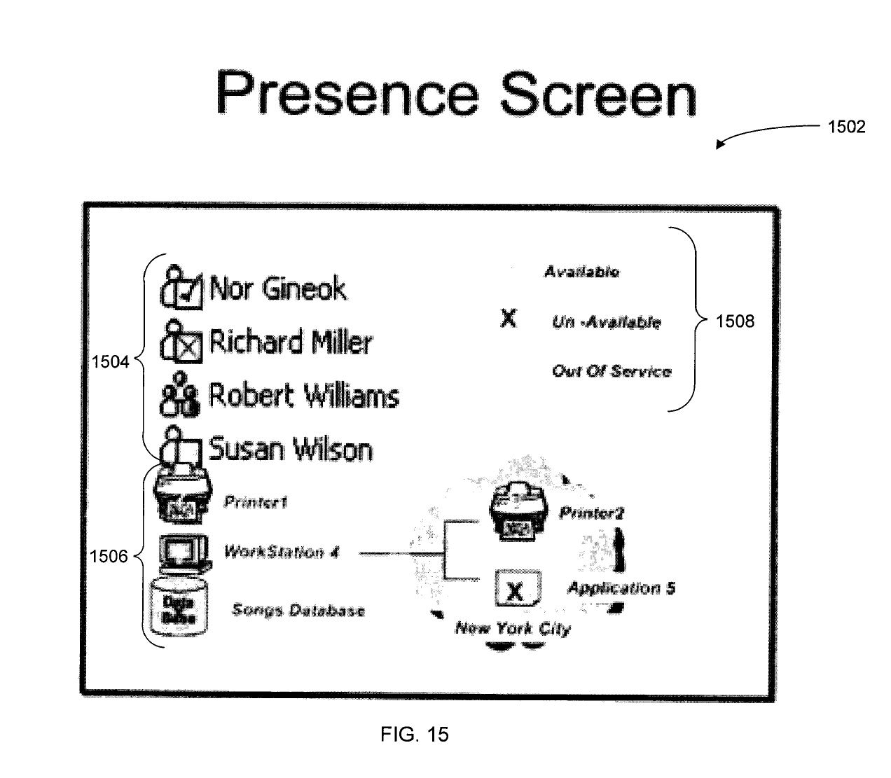

FIG. 15 is a diagram illustrating an example of a presence screen display 1502 that may be used in connection with various embodiments described herein. As shown in FIG. 15, other peers, or terminals, 1504 that are present on the network are displayed, for example, as icons. Also displayed on the presence screen 1502 are different types of services 1506 that are present on the network. Status indicators 1508 can indicate the status, such as available, un-available, or out-of-service, for the peers and services.

In one embodiment Paired Services (PS) are provided. PS are services working on a Point to Point basis between two mobile devices, such as a mobile phone or handsets. Using PS, multiple individuals can use various multimedia applications on their respective mobile device, such as a mobile phone or handset, and interact with each other. One aspect includes having Paired Services work in a Public Land Mobile Network (PLMN) without adding ‘additional Servers’ dedicated to Paired Services or the service offered on top of Paired Services to the network. In one embodiment, the Server on the PLMN network to support the operation of Paired Services is a SMSC which can be used to find the paired Services Partner.

In one embodiment, Paired Services may make use of a GPRS network to transport the user data from one device to another, such as from one phone to a partners phone. In this embodiment, direct IP communication between the two mobile phones can be allowed on the GPRS network using the ports used by the Paired Services. This usually means that both partners are subscribed to the same PLMN.

In one embodiment, using GPRS or a Packet Switched network for data exchange may allow for low latency when exchanging user data in a ‘always on’ mode. For example, one embodiment of Paired Service is a Paired Services Instant Stream which is a low latency streaming Push to Talk (P2T) application which allows two PS partners to communicate in a walky-talky like manner. Paired Services are not limited to GPRS networks, but the Paired Services may be designed in such a way that besides GPRS networks they can be used on EDGE, UMTS, CDMA networks, and other types of networks. Other embodiments of PS include, for example, Continuous Image Update, Continuous Image Update with Voice, Peer 2 Peer gaming, Voice support for multiparty gaming, Bluetooth transport, Content Sharing, Baby Watch, Shared Display, Remote Control Partners Phone, Remote Camera; and the like.

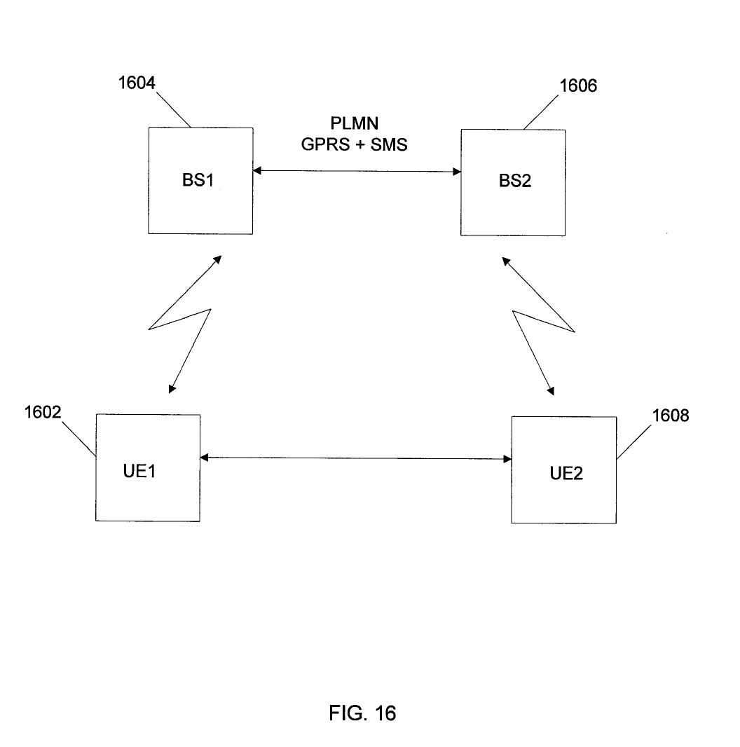

FIG. 16 is a block diagram of an example embodiment of a Paired Services Instant Stream system. The example illustrated in FIG. 16 is a low latency Push to Talk Streaming Service that can allow Walky-Talky like communication between two PS Partners. As shown in FIG. 16 a first wireless device 1602 is in communication with a first base station 1604. The first base station 1604 is also in communication with a second base station 1606. For example, the first and second base stations 1604 and 1606 can be in communication via a PLMN, GPRS and SMS, or other types of networks. The second base station 1606 is also in communication with a second wireless device 1608.

In one embodiment a user of the first wireless device 1602 activates a talk function, such as pushing a “Talk” button, on the first wireless device 1602. The user then speaks and their speech is encoded and packet as payload into data packets, such as IP data packets. The data packets are then streams to the second wireless devices 1608 via the two base stations 1604 and 1606.

The second wireless device 1608 receives the stream of data packets. The second wireless device 1608 extracts the payload from the data packets, decodes the payload and outputs the data, for example, outputting the data to a speaker in the second wireless device 1608 so that a user can hear the speech. In an embodiment, both wireless devices need a GPRS connection.

In another embodiment, the encoded data packets are streamed directly from the first wireless device 1602 to the second wireless device 1608. In still another embodiment, both the first wireless device 1602 and the second wireless device 1608 are in communication with the same base station and the encoded datapackets are streamed from the first wireless device 1602 to the base station and then to the second wireless device 1608. In an embodiment, both wireless devices need a GPRS connection.

Table 1 below provides examples of features for the Paired Services P2T instant stream.

TABLE 1
P2T Instant Stream Features/Paired Services

Finding the partner
Stream establishment
Stream termination
Transmitting
Receiving and playing
Instant sending

In another embodiment, Paired Services Instant Voice (IV) services are provided. The IV services can provide a way to send a sound message using Instant Messaging techniques. In one embodiment, the IV service records sound, creates an IM message and sends it to a selected recipient. The IV service can also provide the capability for receiving incoming sound messages and reproducing them.

Paired Services are generally available to a device that is operating in Paired Mode. Paired Mode means that a Paired Partner has been selected and contacted successfully. In one embodiment, the Paired Partner will be the recipient as well as the sender of PS data. In this embodiment, if a device is not operating in Paired Mode, the paired services will not be used until a device has successfully paired with a partner—and thus entering Paired Mode.

In one embodiment of Paired Services, only one Paired Partner is selected at a given time. In this embodiment, whenever a new Paired Partner is selected, pairing with the current Paired Partner will be released so that there is only one Paired Partner available at a time.

In an embodiment of Paired Services, two operations are performed, finding a Partner and activating Paired Mode; and Media Negotiations between two PS instances running on two partners wireless devices or user equipment (UE).

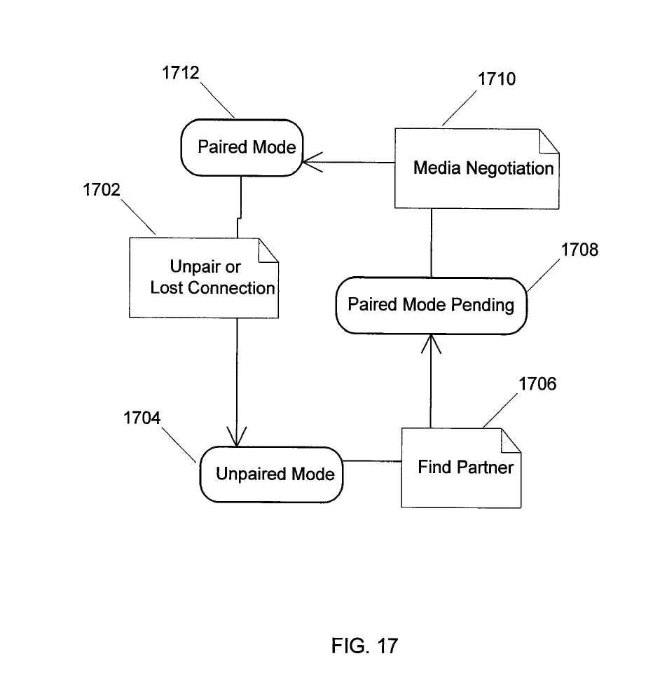

FIG. 17 is a block diagram illustrating an example embodiment of states for a Paired Services. In the example of FIG. 17, a device begins in unpaired, or if a device has lost a connection, state 1702. The device will enter an unpaired state 1704. The device can then enter a find partner stat 1706, where the device will search for a partner. When a partner is found the device will enter a paired mode pending state 1708 where the devices will negotiate a pairing. The device can then enter a media negotiation state 1710 where the paired devices can share media. The device will remain in a paired mode state 1712 until the connection is lost where the device will enter the unpaired or lost connection state 1702.

As noted in the example of FIG. 17, when using PS the first action to be taken is finding a partner to establish paired mode between the 2 UEs. In one embodiment, finding a partner uses a mechanism that is based on SMS for the initial contact. In other embodiments, other mechanisms can be used for finding a partner. In an embodiment using SMS, a ‘pairing request message’ with a specific UDH can be used to initiate finding a partner and transporting required information to establish a GPRS connection between the 2 UEs. For example, the recipient of the pairing request SMS can get the Phone number of the Requester from the SMS envelope.

In one embodiment, the media negotiation state 1710 is based on the SIP and the SDP protocol. Media negotiation allows the users to select which media they want to use for PS. In other embodiments, multiple Paired Services are available and allow the user to select which Paired Services he wishes to use with his partners. Media Negotiation can also used to determine which UE to enter into paired mode with. After a possible Paired Partner has been found using ‘Finding Partner’, then media negotiation can be used to actually pair with that partners UE. In one embodiment, when a UE is in Paired Mode and wants to end Paired Mode with that Paired Partner it can use a SIP BYE to signal to the Partners UE that it wants to end Paired Mode.

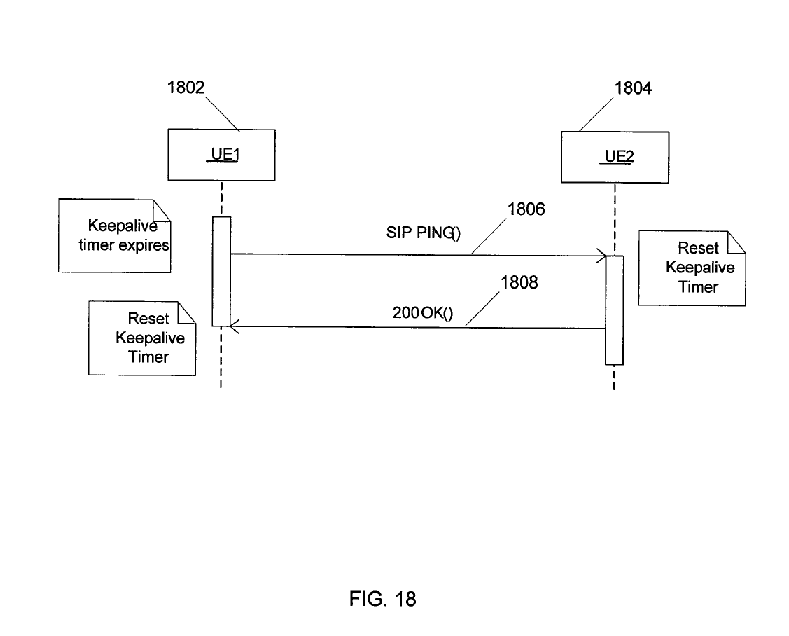

FIG. 18 is a diagram illustrating a call flow for an embodiment of a keep alive mechanism. As shown in FIG. 18, a first and a second UE 1802 and 1804 are paired. The first and second UE 1802 and 1804 can include keep alive timers, Whenever the keep alive timer of a UE expires it sends a SIP PING method to the partners UE. For example, in FIG. 18, the keep alive timer of the first UE 1802 expires and the first UE sends a SIP PING message 1806 to the second UE 1804. When the second UE 1804 receives the SIP PING message 1806 it will reset its keep alive timer and answer with a SIP 200 OK message 1808. When the first UE 1802 receives the SIP 2000 OK message 1808 the first UE 1802 will reset its keep alive timer.

In one embodiment, the keep alive timer can have two discrete values which can be selected by the user:
Low means frequent keep alive packets, high keep alive data traffic, good reliability of connection. The timer can be set to a desired value, such as to 10 minutes.
High means infrequent sending of keep alive packets, low keep alive data traffic, lower reliability of connection. The timer can be set to a longer desired value, such as to 1 hour.

In other embodiments, besides choosing from those two discrete values, a user can select a desired time for the keep alive time, for example, in a range from 1 Min to 60 minutes. In the situation when no 200 OK message is received upon sending a SIP PING, the SIP timer expires. In this case, the UE can resend one more SIP PING messages. If, after a desired number of SIP PING messages have been sent without receiving a reply, then the user can be informed that the connection is broken and needs to be re-established, the UE can then enter Unpaired Mode state 1704.

In one embodiment, when connected to a GPRS network it can happen that a UE gets a new IP address assigned for an established PDP context. This can happen, for example, when a cell reselection occurs. When a UE detects that the IP address for the PDP context it is using for the PS has changed, it can send a SIP INVITE with SDP and adjusts the SDP parameters to convey those changes to the partner's UE. In the situation when that procedure is unsuccessful, for example, the first UE doesn't receive an answer from the second UE, the first UE can try to re-establish Paired.

In one embodiment, re-establishing Paired Mode is tried, when the IP Address of a UE has changed and it is not receiving any answers back from the Paired Partners UE on trying to send that change to his UE. This method can be used when the UE is still in Paired Mode state 1712. In that case the ULE starts again with the Finding Partner procedure. After that media negotiation will be retried. In case this is unsuccessful, the UE can enter an Unpaired Mode state 1704 and notify the PS applications and the user.

In one embodiment, when an IP connection is lost for a UE, for example it is entering a area with no GPRS coverage, the PS can automatically enter the Unpaired Mode on that UE, and notify the user. The other UE, detecting the loss of the connection with the next keep alive packet or the next time the user tries to use a PS, in that case the other UE will enter Unpaired Mode too and will notify its user.

In an embodiment, the PS gives the user the ability to set a Inactivity Timer. The Inactivity Timer can be used to determine the amount, or duration, of inactivity the PS wait for before it will automatically unpair with that partner and free up the radio bearer. Inactivity can mean that there is no IS data exchanged between both UE. In another embodiment, the user can have the ability to disable this timer, which means, PS will never automatically unpair with a Paired Partner.

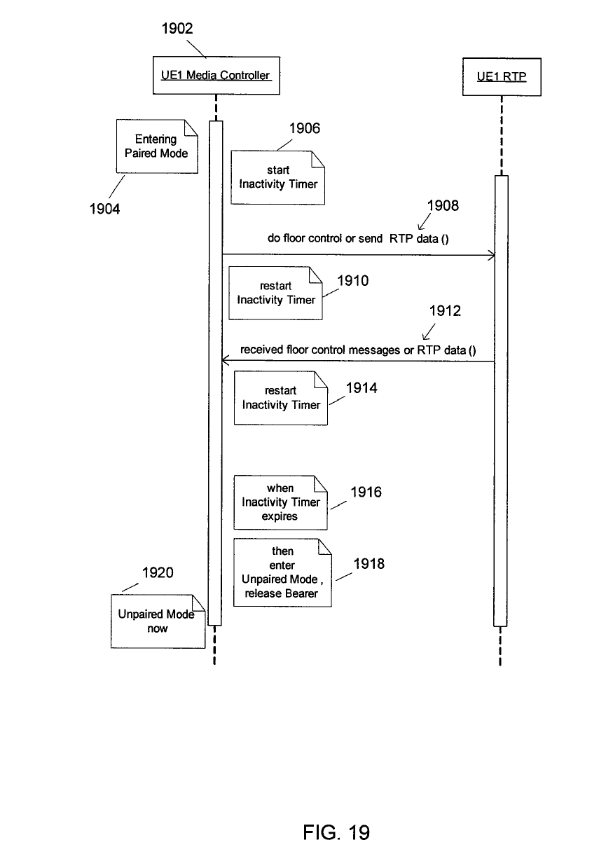

FIG. 19 is a flow diagram illustrating an embodiment of an inactivity timer. As shown in the example of FIG. 19 a UE 1902 enters a paired mode state 1904. The UE then starts 1906 an inactivity timer. The UE can then send a floor control message or send RTP data 1908. The UE then restarts 1910 the inactivity timer. The UE waits, and if it receives s floor control message or RTP data 1912, then the UE restarts 1914 the inactivity timer. If a floor control message or RPT data is not received, then the inactivity timer will expire 1916. If the inactivity timer expires then the UE will release 1918 the bearer and enter an unpaired mode state 1920.

In another embodiment an Instant Stream (IS) functionality is available in Paired Services (PS). Typically, the IS functionality of PS is only available in Paired Mode. In one embodiment, IS provides a Push to Talk (P2T) Service based on AMR encoded Speech data. In one embodiment, the AMR encoded speech data can be transported using. Transport of the RTP packets and their payload can be done utilising UDP or UDP-Lite. For example, one version of IS can use a simple Floor control mechanism which is done using RTCP packets.

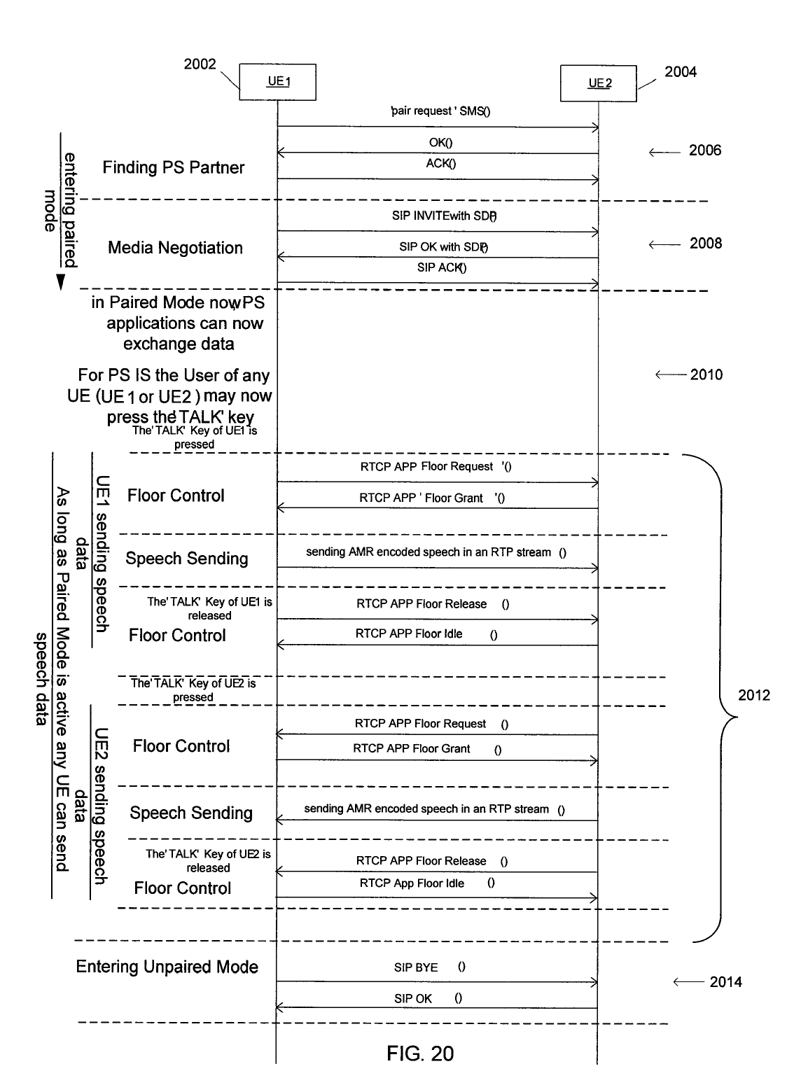

FIG. 20 is a call flow diagram of an embodiment of an instant stream (IS) communication. As illustrated in FIG. 20, after a user presses the ‘TALK’ key, first a floor control procedure takes place in order to test for the other UE's reachability, and ensure that only one user has permission to talk at a given time.

FIG. 20 is a flow diagram of an embodiment of an instant stream pushed to talk paired service. In the example of FIG. 20 a first and a second UE 2002 and 2004 desire to enter into a paired mode state and begin finding a partner 2006. For example, the first UE 2002 sends a paired request to the second UE 2004 for example the paired request can be a SMS message. The second UE 2004 upon receiving the request sends on OK message to the first UE 2002. Upon receiving the OK message the first UE 2002 sends an acknowledge message to the second UE 2004 to establish the partnership.

The first and second UEs 2002 and 2004 then enter into media negotiation 2008. In media negotiation the first UE 2002 sends an SIP invite message to the second UE 2004. Upon receiving the invite message the second UE 2004 responds with an OK message. The first UE 2002 receives the OK message and sends an acknowledgement message back to the second UE 2004. The first and second UEs 2002 and 2004 are now in a paired mode state 2010 and can activate a PS application and exchange data.

In one embodiment, in a paired services instant stream (IS) state 2012 either the first or second UE 2002 or 2004 may now press a talk key to initiate a voice communication. For example, if the first UE 2002 wishes to send a voice communication to the second UE 2004, then the first UE 2002 can enter into a floor control state 2012. In this state the first UE 2002 sends a floor request message to the second UE 2004. If the second UE 2004 is available then it responds with a floor grant message. The first UE 2002 can now send encoded speech to the second UE 2004. For example the first UE 2002 can send AMR encoded speech in an RTP stream to the second UE 2004. When the first UE 2002 has completed its message the talk key will be released. The first UE 2002 will then send a floor release message to the second UE 2004. The second UE 2004 will respond with a floor idle message back to the first UE 2002. If the second UE 2004 then desires to send a voice communication to the first UE 2002, the second UE 2004 will send a floor request message to the first UE 2002. If the first UE 2002 is available it will respond with a floor grant message back to the second UE 2004. The second UE 2004 can then send encoded speech to the first UE 2002. For example the second UE 2004 can send AMR encoded speech as an RTP stream to the first UE 2002. When the second UE 2004 has completed its voice message it can release its talk key. The second UE 2004 will then send a floor release message to the first UE 2002. The first UE 2002 will reply with a floor idle message back to the second UE 2004. When both UEs 2002 and 2004 have completed their voice communication they may desire to enter an unpaired mode 2014. For example the first UE 2002 may send a “bye” message to the second UE 2004 indicating their desire to enter an unpaired mode state. The second UE 2004 can then reply with an OK message and the two devices will then be unpaired.

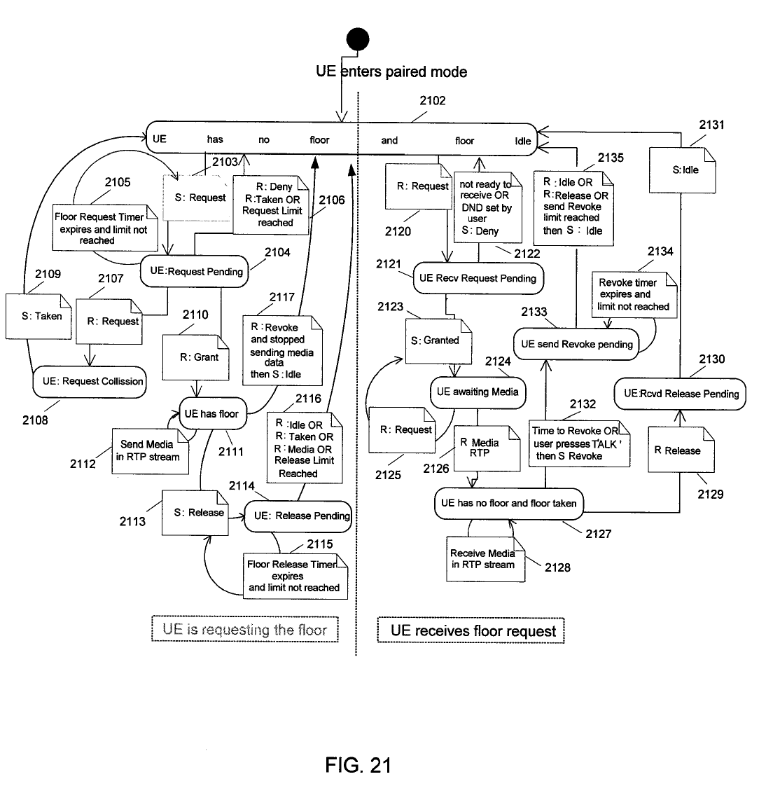

FIG. 21 is a block diagram illustrating floor states for a UE. Typically, floor control uses the RTCP port that has been negotiated during SIP media negotiation for the AMR encoded voice stream. In one embodiment, there are three main floor control procedures:
Floor Request procedure
Floor Release procedure
Floor Revoke procedure

In one embodiment, the following control methods can be used:
Floor Request—A UE requests that it get granted the floor and is therefore allowed to send media data
Floor Release—A UE notifies that it is releasing the floor and has stopped sending media streams.
Floor Deny—The UE is notified that it can't get the floor at that moment.
Floor Grant—Tells that UE that has sent a Floor Request, that it has been granted the floor and that it is allowed to send media data.
Floor Revoke—The UE is notified that it should stop to send the media stream
Floor Idle—When received tells that UE that the floor is idle and can be requested.
Floor Taken—indicates to the UE that another UE currently has the floor.

In an embodiment, the following timers can be used for reliability and to trigger retransmissions:
The UE sends repeatedly Floor Releases until Floor Idle or Floor Taken or a media stream from the PS partners UE is received. The timer value can be set to a desired value, for example it can be set to 10 seconds. After a desired number of tries, such as for example, 6 retries, the UE will stop sending Floor Release and start Re-establishing of Paired Mode.
The UE sends repeatedly Floor Requests until Floor Grant, Taken, Deny or RTP media from the PS partners UE is received. The timer value is set to a desired value, such as 1 second. After a number of retries, such as 6 retries, the UE will stop sending Floor Requests and treat the session as if a Floor Deny had been received. It will start Re-establishing of Paired Mode.
The UE sends repeatedly Floor Revokes until a Floor Idle or Floor Release is received. The timer value is set to a desired value, such as 2 seconds. After a number of retries, such as 3 retries, the UE will stop sending Floor Revoke and discard received RTP packets after RTCP RR values had been updated.

In one embodiment, if the UE receives a ‘Floor Request’ from any UE that it is currently not in paired mode with, it will not answer to the ‘Floor Request.’ In another embodiment, the user may be able to select that he wants to receive IS from unpaired or even unknown partners.

FIG. 21 is a block diagram illustrating floor control states for a UE. Flow begins when the UE enters an initial floor state 2102. If the UE requests the floor, flow continues to block 2103 where the UE sends a request. The UE then enters a request pending state 2104. If the UE does not receive a response to its request within a desired time, and a request limit has not been reached, then flow continues to block 2105 and a floor request timer expires. Flow continues to block 2103 and the UE sends another request.

Returning to block 2104 if the UE receives a deny or receives a taken message or a request limit has been reached flow continues to block 2106 and the UE reenters the initial state 2102. Returning again to block 2104, if the UE receives a request flow continues to block 2107, then in block 2108 the UE detects request collision. In block 2109 the UE sends a taken message then flow continues back to the initial state 2102.

Returning once again to the request pending state 2104, if UE receives a grant to their request flow continues to block 2110. Then, in block 2111, the ULE enters the floor state 2111 and the UE has the floor. The UE can then enter block 2112 and send media, for example, an RTP stream media. Returning to the floor state 2111, the UE can go to block 2113 and send a release the floor message. The UE then enters a release pending state 2114. If a floor release timer expires and a limit on the floor release timer has not been reached the UE will enter block 2115. The UE will return to block 2113 and send a release message and then return to the release pending state 2114.

Returning to release pending state, if the UE receives an idle message, or a taken message, or media, or the release pending timer is reached, the UE will enter block 2116. The UE will then return to the initial floor state 2102. Returning to the floor state 2111, the UE can receive a revoke and stop sending media data message at block 2117, send an idle message, and return to the initial floor state 2102.

Returning to the initial state 2102 if the UE receives a floor request in block 2120 it will enter a received request pending state 2121. If the UE is not ready to grant a floor request or a DND message is sent by the user, the UE will send a deny message in block 2122 and then renter the initial floor state 2102. Returning to the received request pending state 2121, if the UE is available, it can grant a request in block 2123. The UE will then enter a UE awaiting media state 2124. While in the awaiting media state, the UE may receive additional requests in block 2125 which it can respond with a grant message in block 2123 before returning to the awaiting media state 2124.

While in the awaiting media state 2124 the UE can begin to receive media in block 2126, such as an RTP data stream. The UE can then enter the floor state 2127. In the floor state 2127, if the UE does not have the floor and the floor is taken, the UE can receive media in block 2128 and continue to receive media such as an RTP stream.

Returning to the floor state 2127, the UE can send a release message in block 2129. The UE then enters a received release pending state 2130. The UE will then send an idle message in block 2131 and then return to the initial state 2102.

Returning to the floor state 2127, the UE can send a revoke message in block 2132. The revoke message is sent if a predetermined time to revoke was reached, or the user presses the talk button. The UE will then enter a revoke pending state 2133. While in the revoke pending state 2133, if a revoke timer expires and a predetermined number of revoke timer expirations has not been reached, then the UE will return to the revoke pending state 2133. In the revoke pending state 2133, if the UE receives an idle message, or a release message, or the revoke limit has been reached, then the UE will send an idle command in block 2135 and then return to the initial floor state 2102.

In one embodiment, the start of a Talk Burst can be identified by a bit, such as the M-Bit, being set to one, a new SSRC value or a previous end of another talk burst. The End of a Talk Burst can be detected:
when the receiving UE receives a Floor Idle packet
The UE receives RTP media with a new SSRC
A Floor Release Packet is received.

When detecting the end of a Talk Burst, the speech codec in the receiving UE should be reset.

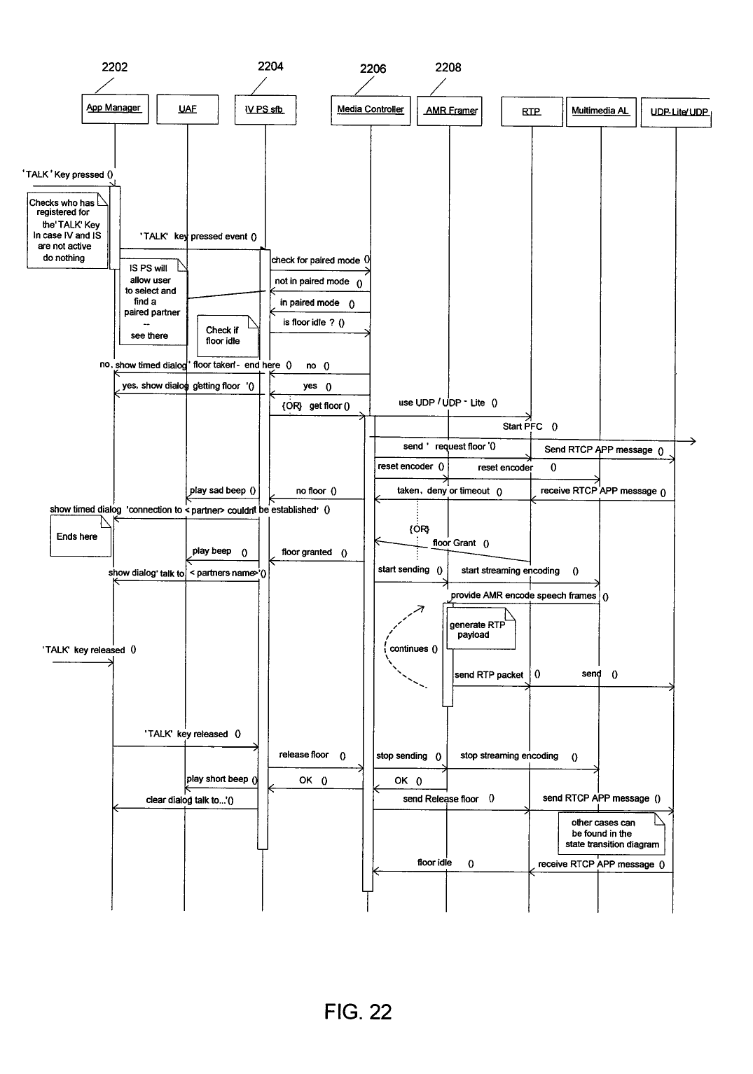

FIG. 22 is a flow diagram illustrating an embodiment of steps a “talk” operation of a UE. An application manager 2202 detects that a talk button has been pressed. The application manager checks to verify what applications are registered for the talk key. In one embodiment, if an instant voice or instant stream application not being active, the application manager will not respond to the talk key. If the instant voice or instant stream are activated the application manager will send a message to indicate the instant voice paired services 2204 that the talk key has been pressed. The instant voice paired services 2204 application will check if the UE is in pair mode. If the UE is not in pair mode, the instant stream paired services application will allow a user to find and select a paired partner. If the instant voice paired services application receives an indication that the device is in pair mode, it will then check if the floor is idle by sending an idle request to a media controller 2206. If the instant voice paired services application receives an indication that the floor is not idle, it will return a message to the application manager 2204 indicating that the floor is taken.

If the instant voice paired services application receives an indication that the floor is idle, it will send a message to the application manager 2202 indicating that the floor is available. In an another embodiment upon receiving an indication that the flow floor is available the instant voice paired services application will send a request for the floor to the media controller 2206. The media controller 2206 will send a request for the floor and will also reset its encoder if the request for the floor comes back to the controller as taken, or denied, or there is a time out. The media controller 2206 will then send a indication to the instant voice paired services application 2204 that there is no floor, which will then send an indication to the application manager 2202 that there is no floor.

If the media controller 2206 request for floor is granted, the media center will indicate to the instant voice paired services application 2204 that the floor as been granted, which will also send an indication to the application manager 2202 that the floor as been granted. The media controller 2206 will then begin sending data, such as, streaming data to an AMR framer 2208. The AMR framer 2208 will format the data and send the data out as payload in data packets. For example, the AMR framer can encode the data into RTP packets and send the RTP packets.

When the user has completed talking, they will release the talk key. The application manager 2202 will detect that the talk key has been released and send an indication to the instant voice paired services application 2204. The instant voice paired services 2204 will send a release floor message to the media controller 2206. The media controller will then stop sending data and reply with an OK message to the instant voice paired services application 2204. The media controller 2206 will then send a floor release message and receive a floor idle message.

In one embodiment, if the ‘TALK’ Key is released prior to receiving an answer to the sent ‘Request Floor’, no RTP stream will be sent to the partners UE. The Media Controller will, after receiving the ‘TALK key released’ key event, send a ‘Release Floor’ to the partners UE without sending any RTP media stream. The Paired Partners UE will interpret the ‘Request Floor’ immediately followed by a ‘Release Floor’ as a user alert and indicate that alert to its user, for example, by a visually and audibly indication.

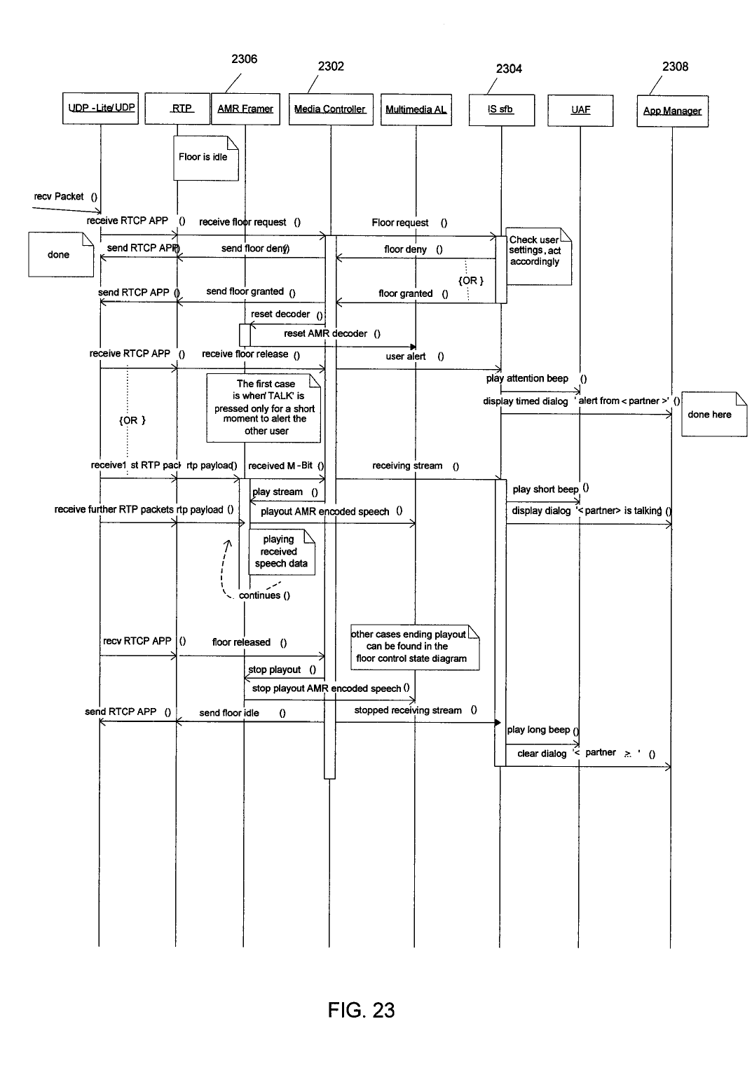

FIG. 23 is a flow diagram of an embodiment of receiving a talk burst. The media controller 2302 will receive a request for the floor. The media controller will send the floor request to the IS application 2304. The IS application 2304 will check the user settings and set up the UE in accordance with the settings. The IS application 2304 will then respond with a floor deny or a floor granted message. If the IS application 2304 denies the request for the floor its sends this message to the media controller 2302 which then replies to the request to the floor with a deny, which terminates the communication. If the IS application 2304 grants the request for the floor it sends a message to the media controller 2302 which then sends a floor granted request back to the UE requesting the floor.

When the floor requested is granted, an AMR framer 2306 resets a decoder. The UE will then receive data. For example, in one embodiment the other user will press the talk key for only a short moment to alert the UE. In this embodiment, the media controller will receive a floor release message. The media controller will then pass this message on to the application manager 2308 which will indicate to the user that another UE has transmitted a message to them. For example, the application manager can apply a short “pay attention” beep to get the attention of the user.

In another embodiment the UE requesting the floor will begin sending data packets, such as, RTP data packets. These data packets will be received by the AMR framer 2306 and then passed to the media controller 2302. The receiving stream will then be passed to the IS application 2304 which will pass the message on to the application manager 2308 so that it can be displayed or played to the user. This will continue until the requesting UE sends a floor release message which is received by the media controller 2302. The media controller 2302 will command the AMR framer to stop play out and also send a floor idle command to the requesting UE. The media controller 2302 will also indicate to the IS application 2304 that the media stream has stopped. The IS application 2304 will send a message to the application manager 2308 that the talk burst has terminated.

In one embodiment, if the receiver of the IS is not in GPRS coverage, the sending UE may receive ICMP unreachable messages—this is dependent on the IP stack implementation in the UE. In this case the UE can continue sending the data stream for a desired duration, such as at least 10 seconds more. If the UE still receives ICMP unreachable messages after that time it can stop sending, inform that user and enter unpaired mode.

In another embodiment, an Instant Voice (IV) message service is available. For example, if there is a dedicated “Talk” button present on the UE, such as a phone, when the user presses the “Talk” button his voice can recorded into memory. When the “Talk” button is released, the recording is complete. In one embodiment, the recording can finish before the user releases the “Talk” button if an exception occurs, for example, if the recording buffer, which has limited size, fills up.

In an embodiment, at the end of recording, the IV service can display a notification message, which includes basic information about the recorded voice message. After a user confirmation, the recorded message can be sent to the currently selected contact.

In one embodiment, if a contact changed its Presence Attribute, so that it is no longer available, a popup message can appear to inform the user about the inability to deliver the voice message. In one embodiment, if the voice message can not be delivered it will be destroyed. In another embodiment, the message may be saved for a desired period of time so that the user can try and send the message later.

In one embodiment, whatever state a device is in, the IV service is always ready to receive an incoming voice message. When a message is received, an indication, such as a sound for new IV message, can notify the user that a message has been receive before the message itself is played. For example, a popup window with text “Instant Voice data from” and Nickname or User-ID can be opened, then t voice message can start playing. In one embodiment, while playing, selected keys on the device can be assigned optional functions, such as, “Speaker ON/OFF”, volume control, “Stop playing” and “Talk.” For example, when a user presses “Speaker ON/OFF” or “volume increase/decrease” keys, they can be handled as speaker volume control. In one embodiment, volume can be controlled using MMI TO interface functions.

In one embodiment, when a user presses a “Stop playing” key, IV stops playing using MMI TO command. If a voice message has been played in its entirety, IV can receive message from the framework containing this information. In both cases, IV can then indicate the end of the message to the user, for example, by producing a short notification beep or display options.

In one embodiment, if the “Talk” button is pressed during playback of received message, IV first stops playing, as if the “Stop playing” key is pressed. After that, IV starts recording of a new user's voice message that is going to be sent to the contact from whom the received voice message has arrived.

In one embodiment, IV starts recording operation using MMI IO, giving the maximum recording duration. The recording is collected in the memory. To end recording, IV issues the stop command to MMI IO. The recording duration is returned, so it specifies the size of recorded voice. It is also possible that recording stops due to condition “buffer full”, or on other exceptional events. In that case, IV may not issue the stop command.

In an embodiment, IV voice message is sent as data in a message to an application. The application may then send a response to IV indicating that the message was delivered to the recipient.

In one embodiment, an IV voice message can be from a handler application for audio messages. The handler application my redirect all messages of that type to the IV application.

In an embodiment, the IV service starts a playing operation using MMI IO, specifying the memory buffer location where voice data is stored, and buffer size. To stop playing, the IV service may issue a stop command to MMI IO. It is also possible that playing stops when an entire voice data message is played, or on other exceptional events. In these cases, the IV services may not issue the stop command.

Those of skill in the art will appreciate that the various illustrative protocol stack layers, modules, and method steps described in connection with the above described figures and the embodiments disclosed herein can often be implemented as electronic hardware, computer software, or combinations of both. To clearly illustrate this interchangeability of hardware and software, various illustrative layers, modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a layer, module, block, or step is for ease of description. Specific functions or steps can be moved from one module, block or step to another without departing from the invention. Moreover, the various illustrative protocol layers, logical blocks, modules, and methods described in connection with the embodiments disclosed herein can be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method of providing multi peer to peer services, the method comprising:
discovering service terminals within a network that can provide a service;
notifying remote terminals of a presence and availability of the service terminals, along with their respective services; and
accessing the service of a selected service terminal by the remote terminal in the network.

2. The method of claim 1, wherein the network is a wireless network.

3. The method of claim 1, wherein the network is a wide area network.

4. The method of claim 1, wherein the network is the Internet.

5. The method of claim 1, wherein discovering comprises querying a terminal and receiving information about services provided by the terminal.

6. The method of claim 1, wherein notifying comprises providing a list of available services to the remote terminal.

7. The method of claim 1, wherein notifying remote terminals comprises comparing a physical location of a service terminal to a remote terminal and notifying the remote terminal of services within a particular geographic region.

8. A service creation server comprising:
a network connection that sends and receives network data; and
a processor that discovers terminals on the network that can provide services, the processor produces a list of available services and outputs the list to the network to notify remote terminals of the available services.

9. The server of claim 8, wherein the processor discovers terminals based on a service presence information of the terminal.

10. The server of claim 8, wherein the processor provides the list of available services to remote terminals.

11. The server of claim 10, wherein the remote terminal is a W-Fi enabled cell phone.

12. The server of claim 10, wherein the remote terminal is a personal digital assistant.

13. A method of providing paired services in a network, the method comprising:
identifying a partner device by a user device;
establishing a partnership between the partner device and the user device such that one partner will receive and send data to the other partner during a paired service session; and
sharing data between one partner and the other partner during a paired session.

14. The method of claim 13, wherein the data shared is voice data.

15. The method of claim 13, wherein the data shared is multimedia data.

16. The method of claim 13, wherein the paired service comprises a push to talk service.

17. The method of claim 13, wherein the paired service comprises an instant stream service.

18. The method of claim 13, wherein the paired service comprises an instant voice service.

19. The method of claim 13, wherein establishing the partnership comprises transmitting an SMS pairing request message.

20. A method of providing multi peer to peer services, the method comprising:
discovering service terminals within a network that can provide a service; and
notifying remote terminals of availability of the service terminals based on presence information of the service terminal.

21. The method of claim 20 wherein the presence information comprises one or more of an application, network information, a logical location, a physical location, a group membership, a security level, or a user profile.

22. The method of claim 20, further comprising presenting the presence information to a user.

23. The method of claim 22, wherein presenting the presence information comprises one or more of a hierarchical presentation, an availability category, a serviceable category, an out-of-service category, a no-service category, a no-security access category, a busy category or an out-of-order category.
